(19) United States
(12) Patent Application Publication
(10) Pub. No.: US 2007/0224469 A1
(43) Pub. Date: Sep. 27, 2007

(54) Fuel reforming apparatus and fuel cell system

(76) Inventors: Yoshiyuki Isozaki, Tokyo (JP); Yuusuke Sato, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/385,821

(22) Filed: Mar. 22, 2006

(30) Foreign Application Priority Data
Mar. 30, 2005 (JP) 2005-097970

(51) Int. Cl. H01M 8/04; H01M 8/06; B01J 8/04

(52) U.S. Cl. 429/20; 422/190; 422/198; 429/24; 429/25

(57) ABSTRACT

A fuel reforming apparatus includes a heat insulating container, a reformer, a CO treatment unit, a reformer heating unit, a heat insulating member and a catalyst unit. The heat insulating container has an opening. The reformer is provided in the heat insulating container and reforms a fuel to obtain a reforming gas containing H₂ and CO. The CO treatment unit reduces CO in the reforming gas. The reformer heating unit comprises a first catalyst for a combustion reaction of hydrogen, and is configured to heat the reformer using the combustion reaction. The heat insulating member covers the opening of the heat insulating container. The catalyst unit is provided in the heat insulating container and includes a second catalyst for an combustion reaction of a flammable gas.

### CROSS-REFERENCE TO RELATED APPLICATIONS

This application is based upon and claims the benefit of priority from prior Japanese Patent Application No. 2005-097970, filed Mar. 30, 2005, the entire contents of which are incorporated herein by reference.

### BACKGROUND OF THE INVENTION

1. Field of the Invention

The present invention relates to a fuel reforming apparatus and a fuel cell system which are suitable for miniaturization.

2. Description of the Related Art

In recent years, a variety of electronic devices such as a portable phone, a video camera and a computer have been miniaturized with the progress of semiconductor technology, and further, their portability has been demanded. As a power supply which satisfies these demands, a portable primary battery and secondary battery have been conventionally used. However, the primary battery and second battery have a limitation in usage time from the viewpoint of their functions, and electronic devices and the like using such a battery are limited in operating time.

That is, although the electronic device can be actuated by replacing a battery if the primary battery is used and its discharge ends, its usage time is short with respect to its weight, and thus, the primary battery is not suitable for portable devices. Although the secondary battery can be recharged after the discharge ends, the usage place of the electronic device is limited because it needs a power supply for recharging and it takes long time to recharge the battery. Particularly, electronic devices incorporating the secondary battery have a limitation in usage time thereof because the battery cannot be replaced even if the discharge of the battery ends. Thus, it is difficult to actuate various small devices for a long time with the conventional primary battery or secondary battery, and a battery suitable for actuation for a longer period has been demanded.

As one of the solutions for such a problem, a fuel cell has recently attracted public attention. The fuel cell has not only an advantage that it is capable of generating a power only by supplying a fuel and an oxidizing agent but also an advantage that it is capable of generating power continuously by only replacing the fuel. For this reason, the fuel cell can be said to be an extremely effective system for actuation of the portable electronic devices if its miniaturization is achieved.

In a general fuel cell field, there has been developed a fuel cell system using a fuel cell. In the fuel cell, a fuel is reformed by a reformer equipped with a reforming catalyst internally to generate a reformed gas containing hydrogen. Examples of the fuel includes water and light hydrocarbon such as a natural gas and naphtha, and water and alcohol such as methanol. The reformed gas is supplied to a fuel electrode of the fuel cell, and air is supplied to an oxidizing agent electrode. Because such a fuel cell system has a higher voltage and secures a higher efficiency than a direct methanol fuel cell or the like which uses a liquid fuel such as methanol, its reduced size and intensified performance can be expected.

The fuel cell system provided with the reformer uses a fuel which contains water and a flammable substance such as carbon hydride and alcohol. A gas (reformed gas) obtained by reformation contains carbon monoxide of about 1% to 2% as byproducts as well as hydrogen. Thus, a sufficient measure for the safety is required for using the fuel cell system provided with the reformer as a power supply of a portable electronic device. An example of this measure has been disclosed in Jpn. Pat. Appln. KOKAI Nos. 2002-93435 and 2003-45457.

Jpn. Pat. Appln. KOKAI No. 2002-93435 has described that, by providing a noble metal catalyst for combustion reaction of hydrogen leaking from a fuel cell or the like into a case accommodating the fuel cell, the leaking hydrogen in the case is prevented from being deposited because the leaking hydrogen in the case can be converted to water by the combustion reaction even when a fan of the fuel cell system is stopped.

Jpn. Pat. Appln. KOKAI No. 2003-45457 has disclosed a fuel cell system in which a reforming apparatus (5) having an evaporating unit (30) and a combustor (31) for heating a reformer (6) is sealed with a leaking gas collecting unit (20) formed of a heat insulating material and having a bottomed cylindrical shape. The combustor (31) in the fuel cell system disclosed in Jpn. Pat. Appln. KOKAI No. 2003-45457 burns a leaking gas from the reforming apparatus (5).

If the fuel cell system provided with the reformer is loaded on a portable device, it is difficult to use a high precision flow rate monitor and control unit because of limitations in size and cost. This makes it difficult to control the temperature of the reformer precisely with only an amount of heat of the catalytic combustion. Generally, the reformer is insulated to reduce loss of heat, and the temperature of the reformer is likely to change greatly due to a slight difference in the amount of catalytic combustion. An example of a method for controlling the temperature of a reformer has been disclosed in Japanese Patent No. 2715500 and Jpn. Pat. Appln. KOKAI No. 11-86893.

Japanese Patent No. 2715500 has described that an optimum heat amount for a catalytic layer of a methanol reforming apparatus is supplied by burning un-reacted hydrogen of a fuel cell with a burner of a methanol reforming apparatus, and the catalytic layer is heated with a heating body when the catalytic layer temperature of the methanol reforming apparatus drops to a specified control temperature range or less.

Jpn. Pat. Appln. KOKAI No. 11-86893 has disclosed that a hydrogen rich gas is generated early at the time of startup or transient response by heating a reformed catalytic layer of a reforming apparatus at the time of startup or transient response, thereby reducing time from the startup to generation of power.

By the way, a nonaqueous secondary battery such as a lithium ion secondary battery has been demanded to secure safety at the time of an abnormal increase in battery internal pressure due to overcharging or short-circuit, or improper handling such as leaving under a high temperature environment for a long time, and to secure safety in ordinary use. Thus, the nonaqueous secondary battery includes a safety valve which is actuated by a battery internal pressure or an anti-explosion valve (for example, Jpn. Pat. Appln. KOKAI Nos. 5-314959 and 9-245759 and Jpn. UM Appln. KOKAI No. 58-17332).

### BRIEF SUMMARY OF THE INVENTION

According to an aspect of the present invention, there is provided a fuel reforming apparatus comprising:

a heat insulating container having an opening;

a reformer which is provided in the heat insulating container and reforms a fuel to obtain a reforming gas containing H₂ and CO;

a CO treatment unit reducing CO in the reforming gas;

a reformer heating unit comprising a first catalyst for a combustion reaction of hydrogen, configured to heat the reformer using the combustion reaction;

a heat insulating member which covers the opening of the heat insulating container; and

a catalyst unit provided in the heat insulating container and including a second catalyst for an combustion reaction of a flammable gas.

According to another aspect of the present invention, there is provided a fuel cell system comprises:

a heat insulating container having an opening;

a reformer which is provided in the heat insulating container and reforms a fuel to obtain a reforming gas containing H₂ and CO;

a CO treatment unit reducing CO in the reforming gas;

a fuel cell which is supplied with the reforming gas from the CO treatment unit;

a reformer heating unit comprising a first catalyst for a combustion reaction of hydrogen, configured to heat the reformer using the combustion reaction;

a heat insulating member which covers the opening of the heat insulating container; and

a catalyst unit provided in the heat insulating container and including a second catalyst for an combustion reaction of a flammable gas.

According to another aspect of the present invention, there is provided a fuel cell system comprising:

a reformer which reforms a fuel to obtain a gas;

a fuel cell comprising at least one cell which occurs a power generation reaction by using the gas;

a first heater which includes a catalyst for a combustion reaction of an unused gas discharged from the fuel cell and heats the reformer using the combustion reaction;

a second heater which heats the reformer;

a temperature controller which executes feedback control on an output power of the second heater based on a temperature of the reformer; and

a heater power control unit controlling a power to be supplied to the second heater according to the following formula (1):
Wₒᵤₜ=W_{cntl}−ΔH_{cmb}×(F_{dsn}−NI/nF) (1)
where Wₒᵤₜ is the power (W) to be supplied to the second heater; W_{cntl} is the output power (W) of the second heater obtained from the feedback control of the temperature controller; ΔH_{cmb} is a combustion heat (J/mol) of the gas; F_{dsn} is a gas supply amount (mol/s) to said at least one cell; N is a quantity of cells which constitute said at least one cell; I is a current (A) per cell; n is a quantity of electrons involved in the power generation reaction; and F is a Faraday constant.

According to another aspect of the present invention, there is provided a fuel cell system comprising:

a reformer which reforms a fuel to obtain a gas;

a fuel cell comprising at least one cell which occurs a power generation reaction by using the gas;

a first heater which includes a catalyst for a combustion reaction of an unused gas discharged from the fuel cell and heats the reformer using the combustion reaction;

a second heater which heats the reformer;

a temperature controller which controls the temperature of the reformer; and

a heater power control unit controlling a power to be supplied to the second heater so as to satisfy the following formula (2):
Wₒᵤₜ=Q1+Q2−ΔH_{cmb}×(F_{dsn}−NI/nF) (2)
where Wₒᵤₜ is the power (W) to be supplied to the second heater; Q1 is a heat quantity (W) necessary for reforming in the reformer; Q2 is a heat loss quantity (W) at the reformer; ΔH_{cmb} is a combustion heat (J/mol) of the gas; F_{dsn} is a gas supply amount (mol/s) to said at least one cell; N is a quantity of cells which constitute said at least one cell; I is a current (A) per cell; n is a quantity of electrons involved in the power generation reaction; and F is a Faraday constant.

According to another aspect of the present invention, there is provided a fuel reforming apparatus comprising:

a reformer which reforms a fuel to obtain a reforming gas containing hydrogen;

a combustor which includes a catalyst for combustion reaction of a flammable gas, and heats the reformer using the combustion reaction; and

a pressure releasing unit ruptured when an internal pressure of the reformer rises, thereby acting as a gas passage from the reformer to the combustor.

According to another aspect of the present invention, there is provided a fuel cell system comprises:

a reformer which reforms a fuel to obtain a reforming gas containing hydrogen;

a fuel cell which generates a power by using hydrogen;

a combustor which includes a catalyst for combustion reaction of a flammable gas, and heats the reformer using the combustion reaction; and

a pressure releasing unit ruptured when an internal pressure of the reformer rises, thereby acting as a gas passage from the reformer to the combustor.

### BRIEF DESCRIPTION OF THE SEVERAL VIEWS OF THE DRAWING

FIG. 1 is a schematic configuration diagram showing a fuel cell system according to a first embodiment of the present invention;

FIG. 2 is a schematic diagram of an air pump for use in the fuel cell system shown in FIG. 1;

FIG. 3 is a perspective view schematically showing a heat insulating container for use in the fuel cell system shown in FIG. 1;

FIG. 4 is a flowchart showing abnormality detection processing of the fuel cell system of the invention;

FIG. 5 is a schematic configuration diagram showing a second embodiment of the fuel reforming apparatus of the invention;

FIG. 6 is a schematic configuration diagram (top view) showing an embodiment of an oxygen supply member provided on the fuel reforming apparatus shown in FIG. 5;

FIG. 7 is a schematic configuration diagram (side view) showing the embodiment of the oxygen supply member provided on the fuel reforming apparatus shown in FIG. 5;

FIG. 8 is a schematic configuration diagram showing another embodiment of the oxygen supply member provided on the fuel reforming apparatus shown in FIG. 5;

FIG. 9 is a schematic configuration diagram showing a fuel cell system according to a third embodiment of the present invention;

FIG. 10 is a schematic configuration diagram showing a fuel cell system according to a fourth embodiment of the present invention;

FIG. 11 is a schematic diagram showing an arrangement of a evaporator, a reformer, a combustor and a heater equipped on the fuel cell system shown in FIG. 10;

FIG. 12 is a schematic diagram showing an arrangement of a evaporator, a reformer, a combustor and a heater equipped on the fuel cell system shown in FIG. 10;

FIG. 13 is a schematic diagram showing an arrangement of a evaporator, a reformer, a combustor and a heater equipped on the fuel cell system shown in FIG. 10;

FIG. 14 is a schematic perspective view showing a reformer and a combustor for use in a fuel reforming apparatus according to a fifth embodiment of the present invention;

FIG. 15 is a plan view showing an example of positional relation between a gas circulation passage of the combustor and a pressure releasing unit of the reformer in the fuel reforming apparatus of FIG. 14;

FIG. 16 is a sectional view showing a configuration example of the pressure releasing unit of FIG. 15;

FIG. 17 is a plan view showing another example of positional relation between the gas circulation passage of the combustor and the pressure releasing unit of the reformer in the fuel reforming apparatus of FIG. 14; and

FIG. 18 is a sectional view showing a configuration example of the pressure releasing unit of FIG. 17.

### DETAILED DESCRIPTION OF THE INVENTION

### First Embodiment

Embodiments of the present invention can provide a fuel reforming apparatus and a fuel cell system having excellent safety and suitable for miniaturization.

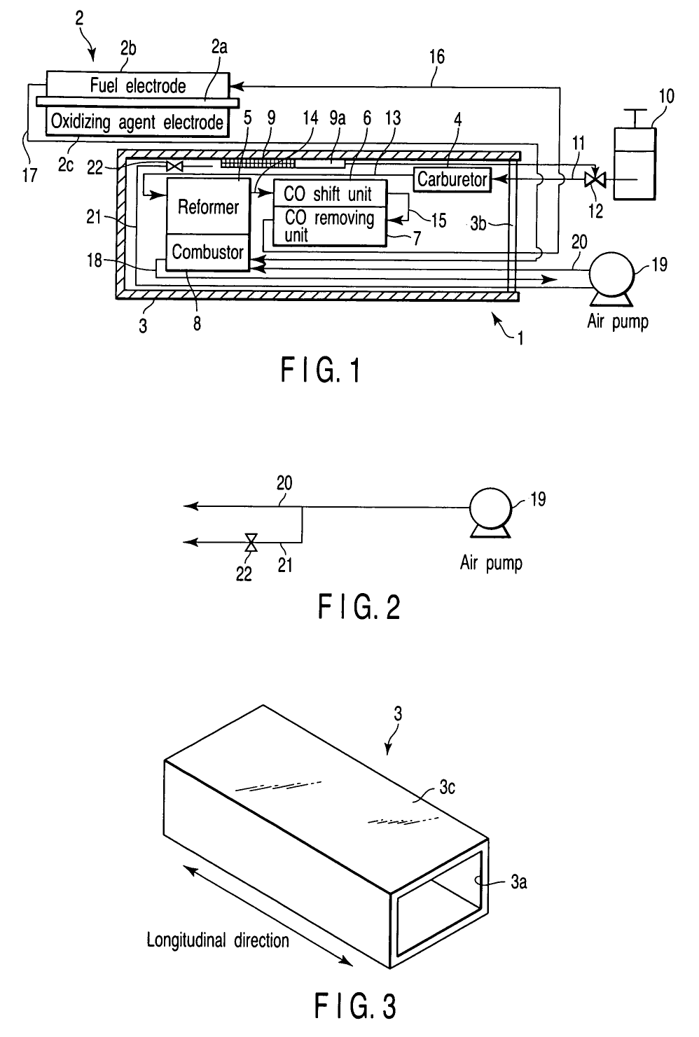

Hereinafter, a first embodiment of the present invention will be described with reference to FIGS. 1 to 3. FIG. 1 is a schematic configuration diagram showing a fuel cell system according to the first embodiment of the invention. FIG. 2 is a schematic diagram of an air pump for use in the fuel cell system shown in FIG. 1. FIG. 3 is a perspective view schematically showing an heat insulating container for use in the fuel cell system of FIG. 1.

The fuel cell system includes a fuel reforming apparatus 1 and a fuel cell 2.

The fuel reforming apparatus 1 comprises: a heat insulating container 3 having an opening 3a in its side face; an evaporator 4 installed within the heat insulating container 3; a reformer 5; a CO treatment unit including a CO shift device 6 and a CO removing device 7; a combustor 8; a catalyst unit 9 arranged on an inner wall of the heat insulating container 3; an heat insulating member 3b covered in the opening 3a of the heat insulating container 3; and a fuel supply unit 10 arranged outside the heat insulating container 3, which supplies a fuel to be reformed to the evaporator 4.

The heat insulating container 3 has a flat shape as shown in FIG. 3, a main face 3c perpendicular to the flatness direction (thickness direction) is rectangular, and the opening 3a is formed in a face perpendicular to the longitudinal direction. A width of the heat insulating container 3 perpendicular to the opening 3a is longer than a width of the heat insulating container 3 along the opening 3a. The heat insulating container 3 is a vacuum heat insulating container having a hollow portion between its inner wall face and outside wall face. On the other hand, the heat insulating member 3b is formed of, for example, mineral wool, ceramic fiber, calcium silicate, vacuum insulating material (for example, lamination of an aluminum layer on both faces of a ceramic fiber or calcium silicate layer), foamed urethane, tile, hard urethane foam, ceramic powder or the like. The ceramic powder is reinforced with inorganic fiber and has a non-closed cell structure of 0.1 μm or less (for example, trade name: Microtherm manufactured by Nippon Microtherm Co., Ltd.). Of them, the ceramic powder reinforced with inorganic fiber and having a non-closed cell structure of 0.1 μm or less can obtain a sufficient heat resistance under a high temperature of 150° C. Although the face perpendicular to the longitudinal direction of the heat insulating container 3 is formed in a flat shape, it may be formed in a square or circular shape. If the outer peripheral face near the opening 3a of the heat insulating container 3 is covered with a lamination film containing aluminum, the heat insulation effect near the opening 3a of the heat insulating container 3 is intensified so as to keep the temperature near the opening 3a low.

A fuel supply pipe 11 connected to the evaporator 4 is taken out through the heat insulating member 3b and connected to the fuel supply unit 10. The fuel supply pipe 11 is provided with a valve 12. When the valve 12 is opened, a fuel supplied to the evaporator 4 through the fuel supply pipe 11 from the fuel supply unit 10 is heated by the combustor 8, so that the fuel is evaporated.

The fuel supply unit 10 stores a fuel of the fuel reforming system. Examples of the fuel include a mixture of methanol and water, a mixture of dimethylether and water, and a mixture of dimethylether, water and alcohol. Although methanol, ethanol or the like is preferable as alcohol, particularly use of methanol is preferable because solubility between dimethylether and water is improved.

As the fuel supply unit 10, for example, a pressure container which can be attached to/detached from the fuel reforming apparatus can be used. If dimethylether is contained in a fuel, it can be fed to the evaporator 4 by using the pressure of dimethylether. In this case, the mixing ratio (mole ratio) between dimethylether and water is ideally 1:3 from a stoichiometric viewpoint. However, an actual fuel reforming system increases an amount of carbon monoxide generated if the mixing ratio is near 1:3. Further, if excessive water can be used for shift reaction and generation of a power which will be described later, the mixing ratio is preferred to be 1:3.5 or more. However, because energy for heating and evaporating a fuel in the evaporator 4 increases, the mixing ratio is preferably 1:3.5 to 1:5.0, and ideally, 1:3.5 to 1:4.0.

The evaporator 4 is connected to the reformer 5 through a supply passage 13 like a pipe. An evaporated fuel is reformed by the reformer 5 and converted to a gas (reformed gas) containing hydrogen. The reformer 5 includes therein a passage for the evaporated fuel to pass through, and an inner wall face of the passage is provided with as a first catalyst a reforming catalyst for accelerating reforming reaction of the evaporated fuel to a reformed gas.

When a fuel contains methanol, it is permissible to use Cu/ZnO/γ-alumina, Pd/ZnO or the like as the reforming catalyst. Such a reforming catalyst accelerates steam reforming reaction in which methanol is reformed to hydrogen and carbon dioxide as indicated in the formula (1).
CH₃OH+H₂O→3H₂+CO₂ (1)

When a fuel contains dimethylether, it is permissible to use a mixture of Pd/ZnO and γ-alumina or a platinum-alumina base catalyst (Pt/Al₂O₃). Such a reforming catalyst can accelerate steam reforming reaction of dimethylether as indicated in the formula (2).
CH₃OCH₃+3H₂O→6H₂+2CO₂ (2)

The Pt amount of the platinum-alumina base catalyst is preferred to be 0.25 wt % or more and 1.0 wt % or less.

To improve the resistance of the reformer 5 to corrosion, use of a noble metal is effective. An effective temperature range of the reforming catalyst is 200 to 400° C. Preferably, the temperature of the reformer 5 is controlled such that the temperature of the surface of the reforming catalyst is 200 to 400° C.

The reformer 5 is connected to the CO shift device 6 through the supply passage 14 like a pipe. The reformed gas contains carbon dioxide and carbon monoxide as byproducts as well as hydrogen. Carbon monoxide can degrade an anode catalyst of the fuel cell, thereby reducing the power generation performance of the fuel cell system. Thus, carbon monoxide and carbon dioxide are shift-reacted with hydrogen by means of the CO shift device 6 to reduce the concentration of CO and to increase the concentration of hydrogen. The CO shift device 6 includes a passage for the reformed gas to pass through, and an inner wall face of the passage is provided with a shift catalyst for accelerating the shift reaction of carbon monoxide contained in the reformed gas.

The CO shift device 6 will be described in detail. The CO shift device 6 includes therein a serpentine-like or parallel-line passage in which the reformed gas flows like the reformer 5. The inner wall face of the passage is provided with a shift catalyst containing a solid base carrying a noble metal including Pt. The shift catalyst can accelerate shift reaction for converting carbon monoxide to carbon dioxide by a reaction expressed by the formula (3), thereby increasing the amount of hydrogen generated.
CO+H₂O→H₂+CO₂ (3)

The shift catalyst will be described in detail. Examples of the solid base include alumina carrying at least one element selected from Ce, Re, K, Mg, Ca, and La. Even if any one of Pd and Ru is used instead of Pt, the same effect can be obtained.

Other well known catalysts of Cu/ZnO base can be used instead of this shift catalyst. To improve the resistance of the CO shift device 6 to corrosion, it is preferable to use a catalyst containing a noble metal including Pt, Pd or Ru. Further, an effective temperature range of the CO shift catalyst is 200 to 300° C. Preferably, the temperature of the CO shift device 6 is controlled such that the temperature of the surface of the CO shift catalyst is 200 to 350° C.

The CO shift device 6 is connected to the CO removing device 7 through the supply passage 15 like a pipe. A reformed gas, which is shift-reacted by the CO shift device 6 and sent to the CO removing device 7, still contains carbon monoxide of 1% or less. CO is a cause which reduces the power generation performance of the fuel cell system as described above. Thus, carbon monoxide is removed by the CO removing device 7 until the concentration of carbon monoxide is 100 ppm or less. The CO removing device 7 includes a passage through which the reformed gas passes, and an inner wall face of the passage is provided with, for example, a methanation catalyst for accelerating methanation reaction of carbon monoxide contained in the reformed gas.

The CO removing device 7 will be explained in detail. The CO shift device 7 includes therein a serpentine-like or parallel-line passage in which the reformed gas flows like the reformer 5 and the CO shift device 6. An inner wall face of the passage is provided with a methanation catalyst including Ru.

A reformed gas, which is reformed by the reformer 5, shift-reacted by the CO shift device 6 and sent to the CO removing device 7, contains carbon dioxide and carbon monoxide as byproducts as well as hydrogen. Carbon monoxide is a cause which degrades an anode catalyst of the fuel cell, thereby reducing the power generation performance as described above. Thus, before the reformer 5 supplies a gas containing hydrogen to the fuel cell 2, the CO removing device 7 methanizes carbon monoxide as shown by the formula (4) to remove carbon monoxide until the concentration thereof is 100 ppm or less.
CO+3H₂→CH₄+H₂ (4)

The methanation catalyst will be described in detail. Preferable examples of the methanation catalyst include:

Ru/Al₂O₃;

Ru/zeolite;

a catalyst containing Ru/Al₂O₃ as its main component and Ru/Al₂O₃ carrying at least one element selected from Mg, Ca, K, La, Ce and Re; and

a catalyst containing Ru/zeolite as its main component and Ru/zeolite carrying at least one element selected from Mg, Ca, K, La, Ce and Re. Particularly, if a fuel containing dimethylether is used, a methanation catalyst containing Ru/Al₂O₃ or Ru/zeolite as its main component is preferable because it deteriorates less.

The fuel cell 2 has a polymer electrolyte membrane 2a, a fuel electrode (anode) 2b formed on the polymer electrolyte membrane 2a, and an oxidizing agent electrode (cathode) 2c formed on a face of the polymer electrolyte membrane 2a on the side opposite to the face having the fuel electrode 2b formed thereon. The CO removing device 7 is connected to a reformed gas take-out pipe 16 for supplying a reformed gas from which carbon monoxide has been removed. The reformed gas take-out pipe 16 is taken out to the outside through the heat insulating member 3b and connected to the fuel electrode 2b of the fuel cell 2. The fuel cell 2 reacts hydrogen in the reformed gas with oxygen in the air to generate a power.

The fuel cell 2 will be described in detail. The fuel cell 2 includes the electrolyte film 2a, the fuel electrode 2b and the oxidizing agent electrode 2c. The electrolyte film 2a has a proton conductivity and is formed of a fluorocarbon polymer having a cation exchange group such as a sulfonate group and a carboxylic acid group, for example, Nafion (registered trademark of Du Pont). The fuel electrode 2b comprises a porous sheet, a carbon black powder carrying PtRu and a water repellent resin binder such as polytetrafluoroethylene (PTFE). The carbon black powder carrying PtRu is held on the porous sheet by the water repellent resin binder. The oxidizing agent electrode 2c comprises a porous sheet, a carbon black powder carrying Pt and a water repellent resin binder such as polytetrafluoroethylene (PTFE). The carbon black powder carrying Pt is held on the porous sheet by the water repellent resin binder. Each of the fuel electrode 2b and the oxidizing agent electrode 2c may contain a sulfonic acid type perfluorocarbon polymer or fine particles coated with the sulfonic acid type perfluorocarbon polymer.

Hydrogen supplied to the fuel electrode 2b reacts as shown by the following formula (5) at the fuel electrode 2b.
H₂→2H⁺+2e⁻ (5)

On the other hand, oxygen supplied to the oxidizing agent electrode 2c reacts as shown by the following formula (6) at the oxidizing agent electrode 2c.
1/2O₂+2H⁻+2e⁻→H₂O (6)

A fuel cell exhaust gas take-in pipe 17 is connected to the combustor 8 serving as a reformer heating unit, and taken out to the outside through the heat insulating member 3b and connected to the fuel cell 2. The fuel cell 2 generates water by reaction between hydrogen and oxygen, and an exhaust gas (a reformed gas after used for power generation) from the fuel cell 2 contains un-reacted hydrogen. The combustor 8 burns the un-reacted hydrogen with oxygen in the air. At this time, the evaporator 4, the reformer 5, the CO shift device 6 and the CO removing device 7 are heated by using a combustion heat generated at the time of combustion. The evaporator 4, the reformer 5, the CO shift device 6, the CO removing device 7 and the combustor 8 are covered with the heat insulating container 3 in order to improve heating efficiency, equalize the temperature and protect components having a low heat resistance such as an electronic circuit located in the neighborhood. A discharge pipe 18 for discharging a combustion gas outside is connected to the combustor 8 and introduced out through the heat insulating member 3b.

The combustor 8 will be described in detail. The combustor 8 includes therein, for example, a serpentine-like or parallel-line type passage through which a reformed gas used for power generation flows. An inner wall face of the passage is provided with a combustion catalyst such as alumina carrying a noble metal such as Pt or Pd, or Pt and Pd. The reason why a noble metal is used for the combustion catalyst is to prevent oxidation and deterioration of the combustion catalyst without provision of additional equipment for preventing oxidation and deterioration of the catalyst when the fuel cell is stopped. In the meantime, the combustor 8 may be of a type using a heater at the same time. Examples of the heater include a ceramic heater bonded to an aluminum plate, and a rod heater buried in an aluminum plate.

Next, the structure of the reformer 5, the CO shift device 6, the CO removing device 7 and the combustor 8 will be described. Here, the reformer 5 will be described by taking an example. The CO shift device 6, the CO removing device 7 and the combustor 8 have the same structure as the reformer 5 although the width and the length of the passage differ depending on the kind of the catalyst and reaction velocity, and description thereof is omitted.

Preferably, at least part of a reaction container configuring the reformer 5 is formed of a material having a high heat conductivity. The reason is to transmit a combustion heat generated in the combustor 8 to the inside of the reformer 5 effectively. Examples of the material having a high heat conductivity include aluminum, copper, aluminum alloy and copper alloy. Further, stainless alloy may be used because it has an excellent resistance to corrosion although its heat conductivity is lower than aluminum, copper, aluminum alloy and copper alloy.

The reaction container may be formed by using a general mechanical processing method or molding method. The general mechanical processing method includes, for example, electron discharge method and milling method. The general molding method includes, for example, forging and casting. Further, it is permissible to use both the mechanical processing method and molding method by, for example, molding a reaction container having no intake pipe or outlet pipe by casting and thereafter, providing a through hole by the mechanical processing method such as by drilling and then welding a tubular member.

The catalyst unit 9 is arranged on the inner wall of a face along the longitudinal direction of the heat insulating container 3 and located above the reformer 5 and the CO treatment unit. The heat insulating container 3 has an opening 3a in a face perpendicular to the longitudinal direction, and the heat insulating member 3b is arranged in the opening 3a. Consequently, a space which is not airtight and not open to the air can be formed in the heat insulating container 3, and the catalyst unit 9 can be arranged in a gas dispersion passage. Thus, if a flammable gas leaks, the flammable gas is likely to remain beside the catalyst unit 9 and can react with the catalyst unit 9 with a high concentration. For this reason, it can convert the flammable gas to harmless water by accelerating the catalyst combustion reaction of the flammable gas and improve the safety of the reforming apparatus. Further, temperature rise due to catalyst reaction occurs quickly, so that a temperature sensor detects it quickly, thereby detecting a leakage of the flammable gas quickly. Incidentally, examples of the flammable gas include an unused fuel (for example, carbon hydride, alcohol), highly explosive hydrogen and carbon monoxide harmful to the human body.

The catalyst unit 9 is preferred to be arranged on an inner wall face of the heat insulating container 3 and above a portion in which a gas is likely to leak. As such a location, for example, above a reactor such as the reformer 5 (particularly, reactor lid and casing edge), above a pipe joint or the like can be mentioned.

Examples the combustion catalyst as the second catalyst to be used for the catalyst unit 9 include well known catalysts such as a platinum-alumina base catalyst (Pt/Al₂O₃), a palladium-alumina base catalyst (Pd/Al₂O₃), a platinum-palladium-alumina base catalyst ((Pt, Pd)/Al₂O₃), and a ruthenium-alumina base catalyst (Ru/Al₂O₃).

To burn leaking hydrogen, a palladium-alumina base catalyst (Pd/Al₂O₃) or a platinum-palladium-alumina base catalyst ((Pt, Pd)/Al₂O₃) is particularly effective. A ruthenium-alumina base catalyst (Ru/Al₂O₃) is particularly effective for the case of carbon monoxide.

Thus, it is preferable to arrange at least two kinds of the above-mentioned catalysts as the combustion catalyst.

Air to be supplied to the catalyst unit 9 and the combustor 8 can be supplied by means of, for example, an air pump 19. The air pump 19 can be made common with the combustor 8 and the catalyst unit 9. The air pump 19 is arranged outside the heat insulating container 3, and a first supply pipe 20 and a second supply pipe 21 are connected the air pump 19. The first supply pipe 20 of the air pump 19 is connected to the combustor 8 through the heat insulating member 3b. On the other hand, the second supply pipe 21 is connected to the catalyst unit 9 through the heat insulating member 3b. A valve 22 which is opened when the temperature rises is provided on the second supply pipe 21. A leaking flammable gas is converted to water by reaction with oxygen contained in the heat insulating container 3 in the presence of the catalyst unit 9. As the reaction progresses, the quantity of oxygen contained in the heat insulating container 3 decreases, and the temperature of the catalyst unit 9 rises. By providing the valve 22 which is opened when the temperature rises, air can be supplied into the heat insulating container 3 when oxygen becomes short due to progressed combustion reaction, so that interruption of detoxification of the leaking gas can be avoided.

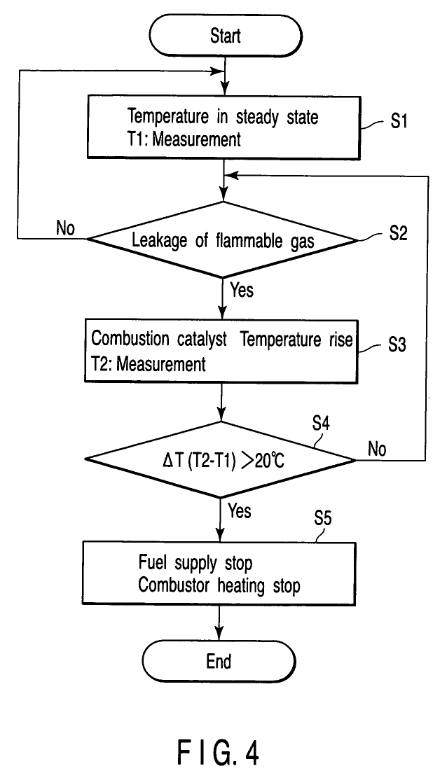

The fuel reforming apparatus is preferred to include a detection unit 9a which detects leakage of a flammable gas due to a rise in temperature by combustion heat of the catalyst unit 9, and a function for stopping fuel supply by the fuel supply unit 10 based on a signal from the detection unit. FIG. 4 is a flowchart showing its abnormality detection processing.

The detection unit monitors for the temperature of the catalyst unit 9, and a temperature T1 of the catalyst unit 9 in a steady state is input to the detection unit (S1). If leakage of a flammable gas occurs (S2), the temperature of the catalyst unit 9 rises (S3). A temperature difference between temperature T2 and temperature T1 is detected by the detection unit (S4). When the temperature difference exceeds 20° C., the valve 12 of the fuel supply unit 10 is closed to stop fuel supply to the evaporator 4, and the first supply pipe 20 of the air pump 19 is closed to stop supply of air to the combustor 8 and stop heating of the combustor 8 (S5). Consequently, the function of the fuel reforming apparatus can be stopped.

When the temperature difference between the temperature T2 and the temperature T1 is less than 20° C., on the other hand, monitoring of the temperature of the catalyst unit 9 is continued without stopping the fuel reforming apparatus.

The fuel reforming apparatus and the fuel cell system according to the embodiment use an heat insulating container having an opening in a face perpendicular to the longitudinal direction, and an heat insulating member is provided in the opening of this heat insulating container. Thus, the inside of the heat insulating container turns to a space which is not airtight and not open to the air. A flammable gas is likely to be deposited in thermally insulated space in which circulation of air cannot occur easily when the flammable gas leaks due to crack or rupture of a pipe caused by external impact such as drop and destruction by pressure. Therefore, the flammable gas can be reacted with a catalyst combustion member with a high concentration, thereby causing the catalyst burning reaction quickly. Consequently, leakage of hydrogen and carbon monoxide to the outside can be prevented. Further, because rise in temperature due to catalyst reaction occurs, the temperature sensor can detect a temperature rise to sense the leakage of the flammable gas quickly.

Because the catalyst unit can be positioned within the dispersion passage for the flammable gas by arranging the catalyst unit on the inner wall of the face along the longitudinal direction of the heat insulating container, it is possible to further accelerated reaction between the flammable gas and the catalyst combustion member.

In addition, provision of an air pump which supplies oxygen to the reformer heating unit and also supplies oxygen to the catalyst unit enables reduction of the size of the fuel reforming apparatus.

### Second Embodiment

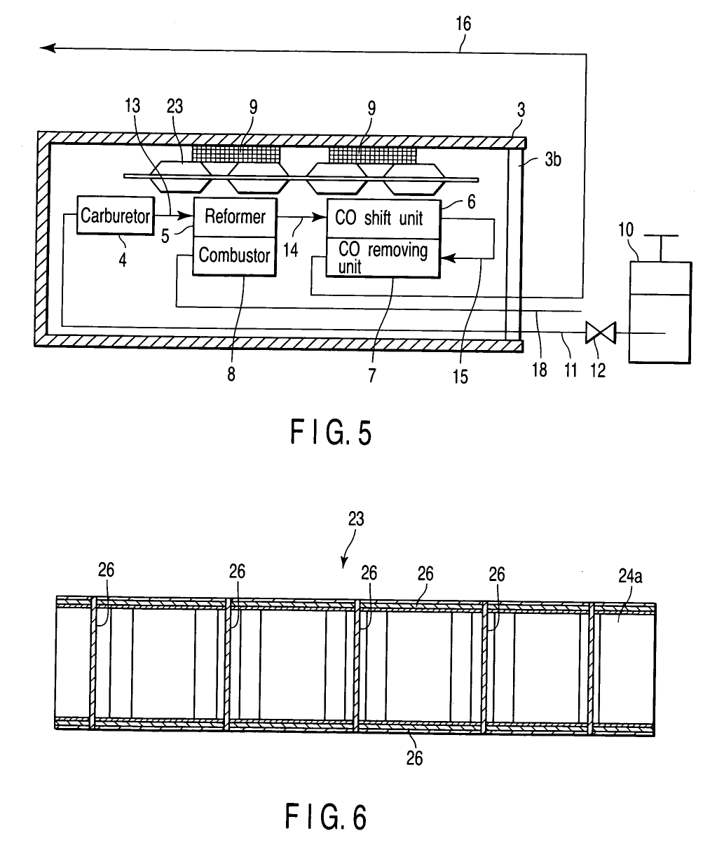

FIG. 5 shows a fuel reforming apparatus according to a second embodiment of the present invention. Like reference numerals are attached to components which exert the same functions as the components described in FIG. 1, and a duplicated description is omitted.

The catalyst unit 9 is arranged on an inner wall of a face along the longitudinal direction of the heat insulating container 3 and above the reformer 5 and the CO treatment unit. As the combustion catalyst (the second catalyst), for example, two kinds of a platinum-palladium-alumina base catalyst ((Pt, Pd)/Al₂O₃) and a ruthenium-alumina base catalyst (Ru/Al₂O₃) are arranged.

An oxygen supply member 23 in which compression air or oxygen is sealed internally is arranged adjacent to the catalyst unit 9.

When a flammable gas leaks, the oxygen supply member 23 ruptures by heat accompanying combustion reaction of the catalyst unit 9. As a consequence, compression air or oxygen sealed internally is discharged. The discharged compression air or oxygen is used for combustion reaction of the catalyst unit 9. With this configuration, when a flammable gas leaks into a vacuum heat insulating container 3, the flammable gas can be converted to water by reaction (combustion) between the catalyst unit 9 and the compression air or oxygen discharged from the oxygen supply member 23 even if the catalyst unit 9 is arranged at a place not on the circulation passage for oxygen. Incidentally, examples of the flammable gas include an unused fuel (for example, carbon hydride, alcohol), highly explosive hydrogen and carbon monoxide harmful to the human body.

The oxygen supply member 23 has an action as a buffer at the same time. Therefore, safety against external impact such as a drop is improved.

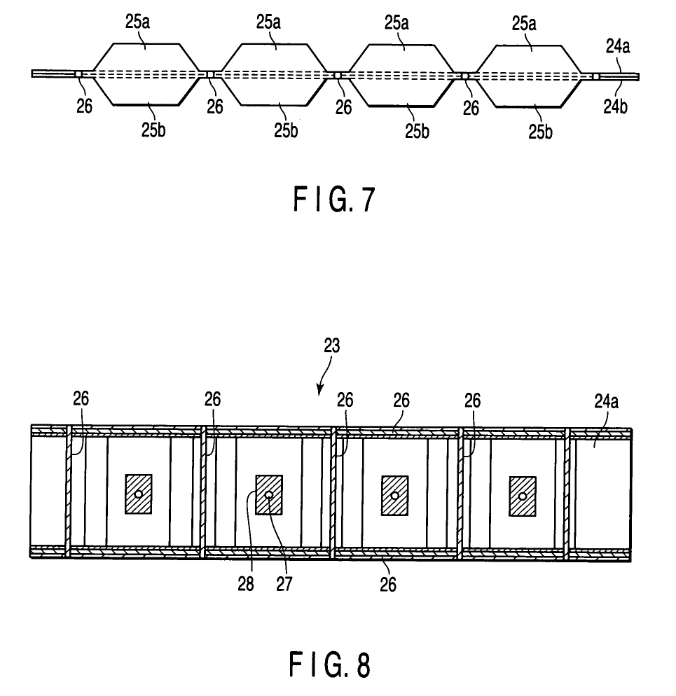

Next, the structure of the oxygen supply member 23 will be described with reference to FIGS. 6 and 7. FIG. 6 is a top view of the oxygen supply member 23, and FIG. 7 is a side view thereof. The oxygen supply member 23 comprises an upper cup member 24a and a lower cup member 24b which are processed by extrusion molding from, for example, aluminum foil. The upper cup member 24a and the lower cup member 24b have a shape in which multiple rectangular concave portions 25a, 25b are arranged laterally in line as shown in FIGS. 6 and 7. A space formed by overlaying the concave portion 25a of the upper cup member 24a and the concave portion 25b of the lower cup member 24b is filled with compression air or oxygen, and an opening end 26 of the concave portion 25a and an opening end 26 of the concave portion 25b are joined to each other by welding.

As the welding method, laser beam welding, ultrasonic fusion and the like are used. It is permissible to fix by using a polyimide base adhesive tape instead of welding.

The oxygen supply member 23 is arranged so as to be in contact with the catalyst unit 9. When a flammable gas leaks, combustion reaction occurs between the leaking gas and oxygen existing in the container on the catalyst surface of the catalyst unit 9. If the reaction continues, a high temperature not lower than the melting point of aluminum is reached on the surface of the combustion catalyst. As a result, the oxygen supply member 23 is ruptured, so that compressed air or oxygen is discharged from inside.

If a thin portion is formed at a portion of the oxygen supply member 23 in contact with the catalyst unit 9, compressed air or oxygen is discharged securely, which is preferable.

It is permissible to provide a hole 27 at a portion of the oxygen supply member 23 in contact with the catalyst unit 9, fill a space in the oxygen supply means 23 with compressed air or oxygen, and then close the hole 27 with a polyimide base adhesive tape 28. With this configuration, the polyimide base adhesive tape 28 is thermally decomposed by combustion heat of the combustion catalyst, so that the compressed air or oxygen can be discharged securely.

According to the fuel reforming apparatus and the fuel cell system of the second embodiment, it is possible to obtain a similar effect as the effect of the first embodiment. In addition to this effect, the second embodiment can provide another effect. In the second embodiment, the oxygen supply member is arranged in the heat insulating container so as to be in contact with the catalyst unit, and the oxygen supply member contains compression air or oxygen gas. Thus, when a flammable gas leaks and the temperature of the catalyst unit rises due to heat accompanying the combustion reaction, the oxygen supply member ruptures. As a result, the compression air or oxygen sealed in the oxygen supply member is discharged, so that combustion reaction by the catalyst unit can be continued. With such a configuration, the safety against the leaking gas can be secured even if the catalyst unit is arranged at a place not on the circulation passage for oxygen.

### Third Embodiment

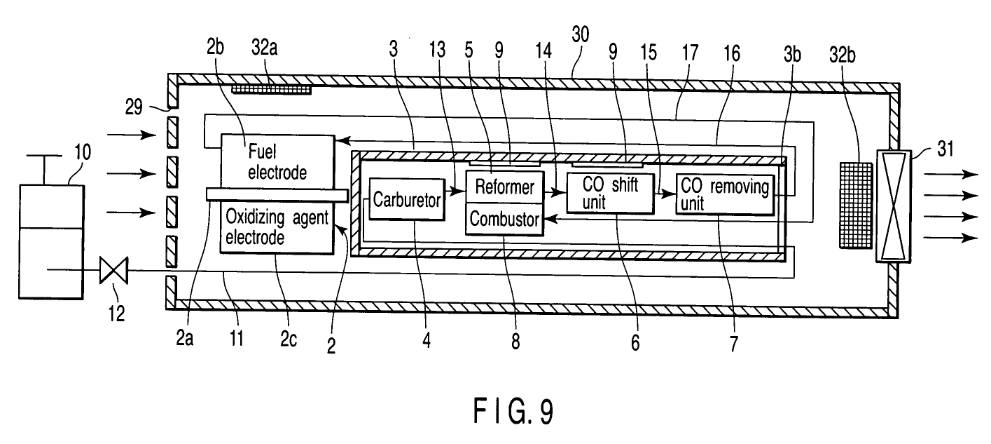

FIG. 9 shows a fuel cell system according to a third embodiment of the present invention. Like reference numerals are attached to components which exert the same function as the component described in FIG. 1, and a duplicated description is omitted.

A housing 30 having a plurality of openings 29 in one side face (left side face of FIG. 9) includes the fuel reforming apparatus and the fuel cell 2 described in the first embodiment. The housing 30 has a fan 31 on a side face opposite to the side in which the openings 29 are formed. By forming the openings 29 in the side face of the housing 30 and providing the fan 31 on the opposite side face, an air flow in the housing 30 is improved. As a consequence, a sufficient amount of an oxidizing agent (air) can be supplied to the oxidizing agent electrode 2c of the fuel cell 2. A housing catalyst unit 32a has a catalyst for burning a flammable gas leaking into the housing 30 by reaction with oxygen. The housing catalyst unit 32a is arranged on an inner wall face of the housing 30 above the fuel cell 2. A housing catalyst unit 32b is arranged on the side face provided with the fan 31. When hydrogen or the like leaks from the fuel cell 2, combustion reaction of the leaking gas can be accelerated by the housing catalyst unit 32a arranged above the fuel cell 2 and the housing catalyst unit 32b arranged on a latter stage in the flow direction of air, so that flow-out of the leaking gas out of the housing can be prevented.

Therefore, according to the third embodiment, high safety can be secured for the fuel cell as well as the reforming apparatus.

The same kind of the catalyst unit 9 can be used for combustion catalysts of the housing catalyst units 32a, 32b.

In the meantime, it should not be understood that the description of the respective embodiments and the accompanying drawings restrict the present invention. This disclosure of the invention enables those skilled in the art to carry out a variety of substituted embodiments, examples and application technologies. The fuel reforming apparatus and the fuel cell system according to the respective embodiments described above can be used for manufacturing of hydrogen and power generation used for various purposes. According to the present invention, even if highly explosive hydrogen or carbon monoxide harmful to humans happens to leak from the reformer, the highly explosive hydrogen or carbon monoxide is converted to water by reaction (combustion) with the combustion catalyst arranged in the heat insulating container. For this reason, the highly explosive hydrogen or carbon monoxide harmful to humans can hardly leak out of the heat insulating container. Thus, the safety against an external impact such as drop is improved. Therefore, the fuel reforming apparatus and the fuel cell system of the present invention are extremely useful as not only a portable power supply but also a power supply for use in portable and small electronic devices such as a notebook type personal computer.

In addition to the effects of the first and second embodiments, the fuel reforming apparatus and the fuel cell system of the embodiment can secure the safety at the time of leakage of a flammable gas in the fuel reforming apparatus and the safety against leakage of a flammable gas such as a reformed gas from a fuel cell.

### Fourth Embodiment

A fourth embodiment of the present invention can provide a fuel cell system capable of achieving both temperature control and heating efficiency of a reformer.

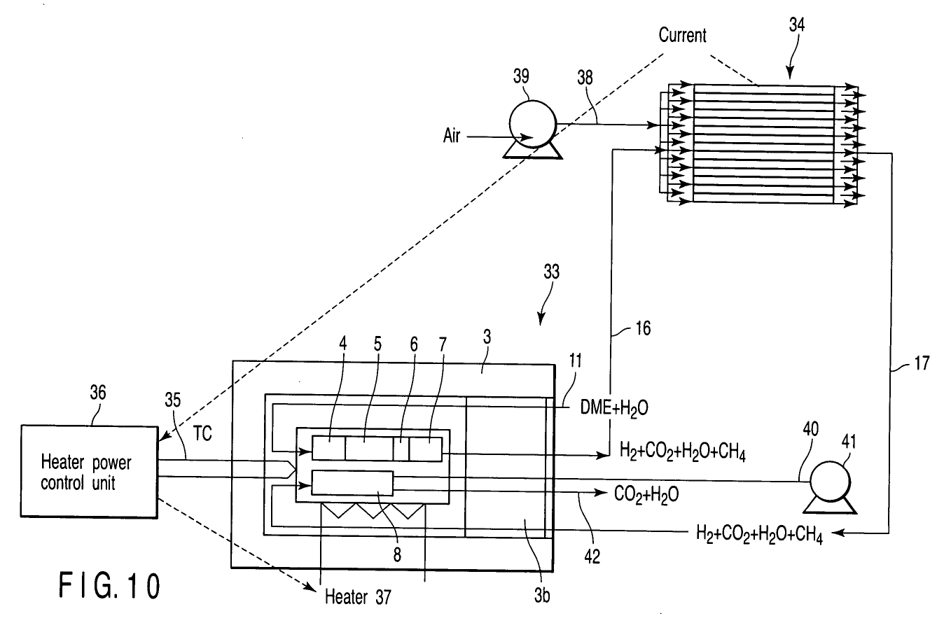

FIG. 10 shows a fuel cell system according to the fourth embodiment of the invention. Like reference numerals are attached to components which exert the same functions as the components described in FIG. 1, and a duplicated description thereof is omitted.

The fuel cell system comprises a fuel reforming apparatus 33, a fuel cell stack 34, a temperature controller 35 having temperature measuring unit for the evaporator 4 and the reformer 5, and a heater power control device 36. A thermocouple, thermister or the like can be used as temperature measuring unit for a catalyst layer. The fuel reforming apparatus 33 comprises the heat insulating container 3, the evaporator 4, the reformer 5, the CO treatment unit (including the CO shift device 6 and CO treatment unit 7) and the combustor 8 serving as a catalyst combustion heater (first heater). The fuel reforming apparatus 33 also includes a second heater 37 within the heat insulating container 3. Examples of the heater 37 include a ceramic heater bonded to an aluminum plate, a rod heater buried in an aluminum plate, and a sheath heater.

A fuel cell for use in the fuel cell system is preferred to be a polymer electrolyte membrane fuel cell. Thus, it is recommendable to use a plurality of membrane electrode assembly (MEA) comprising a fuel electrode, an oxidizing agent electrode, and a polymer electrolyte membrane arranged between these electrodes as the fuel cell stack 34. As the fuel electrode, oxidizing agent electrode and polymer electrolyte membrane, the same components as described in the first embodiment can be mentioned.

Unit which supplies a fuel of, for example, dimethylether (DME) and water is connected to the evaporator 4 through the fuel supply pipe 11. As this unit, the same component as described in the first embodiment can be used.

A reformed gas (including, for example, H₂, CO₂, H₂O, fine amounts of CO and CH₄) subjected to CO treatment by the CO shift device 6 and the CO removing device 7 is supplied to the fuel cell stack 34 through the reformed gas take-out pipe 16 connected to the CO removing device 7. Further, an oxidizing agent (air) is supplied to the fuel cell stack 34 by an air pump 39 connected through a pipe 38.

Exhaust gas (including, for example, H₂, CO₂, H₂O and CH₄) discharged from the fuel cell stack 34 is supplied to the combustor 8 through the exhaust gas take-in pipe 17. An oxidizing agent (air) is supplied to the combustor 8 by an air pump 41 connected through a pipe 40.

The combustor 8 serving as the catalyst combustion heater burns un-reacted hydrogen contained in the exhaust gas by using oxygen supplied by the air pump 41. The evaporator 4, the reformer 5, the CO shift device 6 and the CO removing device 7 are heated by using a combustion heat generated at the time of combustion. A discharge pipe 42 for discharging a combustion gas (including, for example, CO₂ and H₂O) outside is connected to the combustor 8, and introduced out through the heat insulating member 3b.

The specific configuration of the combustor 8 can be the same as described in the first embodiment.

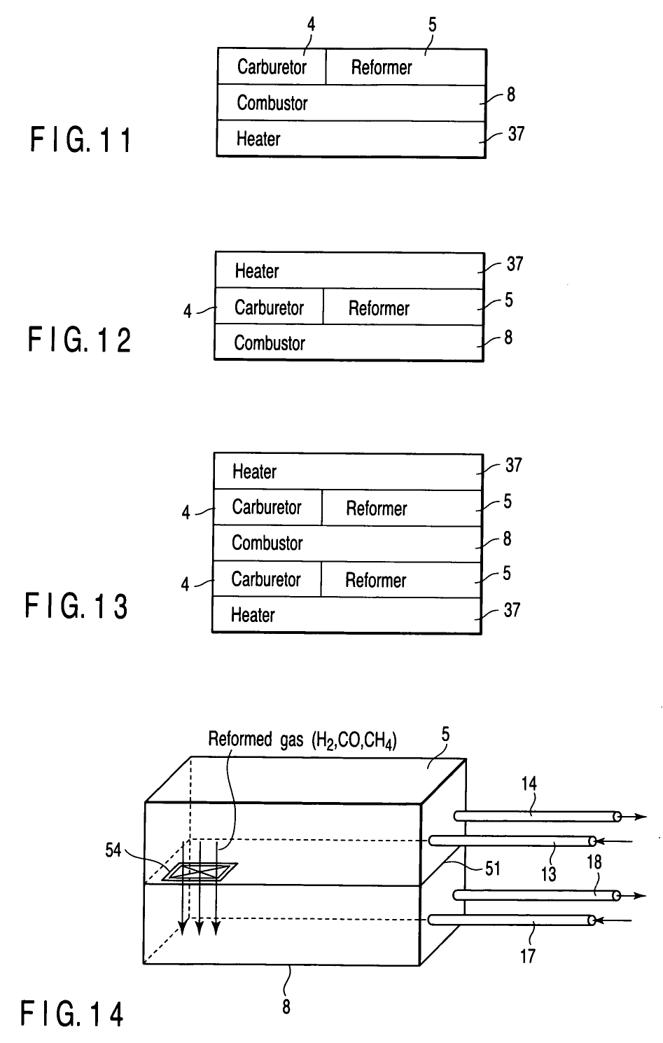

The arrangement of the evaporator 4, the reformer 5, the combustor 8 and the heater 37 within the fuel reforming apparatus can be as shown in FIGS. 11 to 13, for example.

FIG. 11 shows an example in which the combustor 8 and the heater 37 are arranged on one side of the evaporator 4 and the reformer 5. FIG. 12 shows an example in which the heater 37 is arranged on one side of the evaporator 4 and the reformer 5 while the combustor 8 is arranged on the opposite side thereto. FIG. 13 shows an example in which the evaporator 4 and the reformer 5 are arranged on both sides of the combustor 8 and the heater 37 is arranged outside the evaporator 4 and the reformer 5. Of them, the configuration shown in FIG. 12 is preferable because the structure is simple and heat of the heater and catalyst combustion is easily transmitted to the reformer 5.

The temperature controller 35 can execute feedback control on an output power of the second heater based on the temperature of the reformer 5 by monitoring the temperature of the reformer 5. A control signal from the temperature controller 35 is sent to the heater power control device 36 without feedback to the heater 37. The heater power control device 36 measures a current (A) of the fuel cell stack 34, and corrects a power to be supplied to the heater 37 according to the following formula by using the obtained measurement value and the control signal from the temperature controller 35:
Wₒᵤₜ=W_{cntl}−ΔH_{cmb}×(F_{dsn}−NI/nF)
where Wₒᵤₜ is a power (W) to be supplied to the heater 37; W_{cntl} is an output power (W) of the second heater at the time of feedback control by the temperature controller 35; ΔH_{cmb} is a combustion heat (J/mol) of a hydrogen gas contained in a reformed gas; F_{dsn} is a hydrogen gas supply amount (mol/s) to the fuel cell stack 34; N is a quantity of cells (quantity of MEA) which constitute the fuel cell stack 34; I is a current (A) per cell which constitutes the fuel cell stack 34; n is a quantity of electrons in the power generation reaction formula; and F is the Faraday constant (about 96500 C/mol).

A gas used in the fuel cell is not restricted to reformed gas including hydrogen. A reaction formula for an anode, a reaction formula for a cathode, and a catalyst combustion reaction formula in case of hydrogen are shown below.
Anode: H₂→2H⁺+2e⁻
Cathode: 2H⁺+2e⁻+1/2O₂→H₂O
Catalyst combustion: H₂+1/2O₂→H₂O

In the case of hydrogen, n is 2 as indicated above.

The hydrogen consumed in the fuel cell stack 34 can be expressed in NI/nF. The flow rate of the hydrogen used for the catalyst combustion can be estimated by subtracting the amount consumed in the fuel cell from the flow rate F_{dsn} of the hydrogen to be sent to the fuel cell stack 34. The flow rate F_{dsn} is equal to a hydrogen gas supply amount. An amount Wₒᵤₜ is obtained by subtracting the heat quantity of catalyst combustion from the output power of the second heater W_{cntl} at the time of feedback control by the temperature controller 35. The heat quantity of catalyst combustion is obtained from a product of an estimated hydrogen flow rate for use in the catalyst combustion and ΔH_{cmb}. The obtained Wₒᵤₜ is supplied to the heater 37, so that the temperature of the reformer 4 can be maintained at a substantially constant level substantially to the same extent as when only the heater 37 is used as a heat source. This makes it possible to provide a small and safe fuel cell system which can be applied as a power supply for a portable electronic device. As, for example, a PID constant for feedback control of the temperature controller 35, it is permissible to use one obtained according to an ordinary method depending on a temperature response characteristic and the like at the time when no catalyst combustion is used. Heat supplied by the heater 37 and catalyst combustion is a value substantially equal to W_{cntl}.

For example, assume that hydrogen of 250 sccm is generated by the reformer 5 and that hydrogen of 200 sccm is consumed for power generation in the fuel cell stack 34 while hydrogen of 50 sccm is supplied to the catalyst combustion. The amount of hydrogen used for power generation in the fuel cell stack 34 varies depending on fluctuation of a current in the fuel cell stack 34. However, because according to the present invention, the amount of hydrogen supplied to the catalyst combustion can be estimated in consideration of the fluctuation of the amount of hydrogen consumed in the fuel cell stack 34, temperature control can be carried out by heater and catalyst combustion.

When no feedback control by the temperature controller is carried out, the power to be supplied to the heater can be controlled according to the following formula:
Wₒᵤₜ=Q1+Q2−ΔH_{cmb}×(F_{dsn}−NI/nF)
where Wₒᵤₜ is a power (W) to be supplied to the heater; Q1 is a heat quantity (W) necessary for reforming reaction in the reformer; Q2 is a heat loss quantity (W) at the reformer; ΔH_{cmb} is a combustion heat (J/mol) of a hydrogen gas contained in a reformed gas; F_{dsn} is a hydrogen gas supply amount (mol/s) to an electromotive unit of the fuel cell; N is a quantity of cells constituting the electromotive unit; I is a current (A) per cell constituting the electromotive unit; n is a quantity of electrons in the power generation reaction formula; and F is the Faraday constant (about 96500 C/mol).

To raise the temperature of the reformer from a room temperature to a reaction temperature, it is preferable to supply a power larger than that expressed by the formula, and the power control based on the above formula is preferred to be carried out when the temperature of the reformer is within the setting temperature range. In this case, the setting temperature range is 350° C.±10° or less, that is, it is preferably 360° C. or less, more preferably, 350° C. or less, and further preferably, 340° C. or less. As for the temperature fluctuation, a range of temperature abnormality detection (T2-T1) of the first embodiment needs to be less than 20° C.

Escape of the heat from the reformer depends on a temperature difference between the temperature of the reformer and the ambient temperature. This relation may be held in a table or may be estimated according to a relation formula like Q2=f(Trfm, Tenv) to balance heat and control the temperature.

Consider that DME and water are supplied to the reformer as a fuel. It is designed to supply a heat of 9 W by catalyst combustion {ΔH_{cmb}×(F_{dsn}−NI/nF)} when the reforming heat Q1 is 8 W and the heat loss Q2 is 3 W. The temperature of the reformer can be maintained at a constant level with a high heat efficiency by heating by about 2 W with the heater. The heat ratio can be arbitrarily selected like 12.5 W by catalyst combustion and 0.5 W by the heater. The smaller heating by the heater, the more the heat efficiency of reforming is improved. A heat supplied by catalyst combustion needs to be smaller than a sum of the reforming heat Q1 and the heat loss Q2. Although the temperature control of the reformer 5 is exemplified here, the same method can be applied to temperature control of the evaporator 4 and heat control for the evaporator 4 and the reformer 5 in combination. If the evaporator 4 is included, it is necessary to include a sensible heat for heating a fuel and a latent heat for evaporation in Q1.

In FIG. 10 described previously, the heat insulating container 3 having the opening 3a in the longitudinal direction is used, and the heat insulating member 3b is arranged in the opening 3a of the heat insulating container 3. Thus, the safety upon leakage of a flammable gas can be intensified by arranging the catalyst unit 9 within the heat insulating container 3 as described in the first embodiment. The safety upon leakage of a flammable gas can be further increased by using the oxygen supply member 23 described in the second embodiment.

If the amount of the hydrogen consumed in the fuel cell changes, the heat quantity generated by combustion of the combustion catalyst changes. For example, consider a system which monitors the temperature of the reformer with a thermocouple or the like and executes feedback control depending on a temperature difference between a monitor temperature and a target temperature. With reforming reaction generated by supplying the fuel, the feedback control is executed to maintain the reformer at 350° C. without catalyst combustion. In this case, the temperature of the reformer is maintained at about 350° C. by executing, for example, the PID control. If the catalyst combustion is generated by supplying the reformed gas to the catalyst combustor in this state, the temperature of the reformer rises. Although the output of the heater is dropped to try to maintain the temperature at 350° C. when the feedback control is executed, the amount of the hydrogen consumed in the fuel cell changes depending on a power generation state. For this reason, the heat quantity generated by the catalyst combustion changes, thereby making it difficult to maintain the temperature of the reformer at a constant level. Particularly, when escape of the heat is minimized by the heat insulating material, a slight change of the heat quantity generated in the catalyst combustion changes the temperature of the reformer largely.

Because the fuel cell system of this embodiment can estimate the amount of hydrogen not consumed from the amount of hydrogen supplied to the fuel cell electromotive unit and current of the fuel cell electromotive unit, the amount of the catalyst combustion can be estimated based on a change in power generation state or a change in the amount of the consumed hydrogen. The temperature of the reformer can be maintained at a substantially constant level by adjusting the power to be supplied to the heater based on this estimation result. Further, because the necessity of supplying an excessive power to the heater is eliminated by adding the change in the amount of the catalyst combustion, the heat efficiency of the reformer can be improved.

### Fifth Embodiment

If a gas passage is clogged for some reason in a fuel cell system having a reformer so that the internal pressure of the reformer rises abnormally, there is a fear that the reformer may be ruptured and consequently, a fuel reforming apparatus and fuel cell system may be damaged. A fuel reforming apparatus described below can improve the safety when the internal pressure of the reformer rises.

That is, the fuel reforming apparatus comprising:

a reformer which reforms a fuel so as to obtain a reformed gas containing hydrogen;

a combustor which is arranged adjacent to the reformer, includes a combustion catalyst for combustion reaction of a flammable gas, and heats the reformer by using a combustion heat by the combustion reaction; and

a pressure releasing unit which is provided between the reformer and the combustor and is ruptured by a rise in internal pressure of the reformer, thereby acting as a gas passage from the reformer to the combustor.

In the nonaqueous secondary batteries disclosed in the above-described Jpn. Pat. Appln. KOKAI Nos. 5-314959 and 9-245759 and Jpn. UM Appln. KOKAI No. 58-17332, the safety valve is ruptured when the internal pressure of the cell becomes a predetermined value or more so that a gas filling the inside of the cell container is discharged out through the safety valve, thereby preventing the cell from exploding.

On the other hand, the reformed gas obtained by the reformer contains carbon monoxide harmful to humans as well as highly explosive hydrogen. Thus, if the safety valve mechanism applied to the lithium ion secondary battery disclosed in the above-described Jpn. Pat. Appln. KOKAI Nos. 5-314959 and 9-245759 and Jpn. UM Appln. KOKAI No. 58-17332 is used as it is, highly explosive hydrogen and carbon monoxide harmful to humans are discharged, thereby possibly inducing damages on humans or matters.

According to the fuel reforming apparatus, when the gas passage is clogged by a catalyst dropped from the inner wall face of the passage or a mixing foreign matter and the internal pressure of the reformer rises abnormally, a pressure releasing unit is opened by the gas pressure in the reformer so as to allow the gas in the reformer to flow into the combustor. The gas in the reformer can be burned in the combustor by catalyst reaction to a harmless state because most of the gas is a flammable gas such as hydrogen and carbon monoxide. Thus, damage due to rise in pressure and leakage of highly explosive hydrogen and carbon monoxide harmful to humans can be prevented, thereby providing a highly safety fuel reforming apparatus.

As the pressure releasing unit, it is permissible to use a portion having a pressure releasing passage and a metal valve plate having a thin portion which closes the pressure releasing passage or to form the portion in a small thickness instead of providing the passage.

The pressure releasing unit is preferred to be arranged at a position on the boundary between the reformer and the combustor, the position communicating with the upstream of the gas flow passage in the combustor. As a consequence, the gas flowing from the reformer into the combustor can be burnt efficiently. Particularly, when the combustor includes plural gas flow passages in which a combustion catalyst is formed on the wall face thereof, it is preferable that a pressure releasing unit faces an entry of each gas passage or an introduction passage for introducing the gas into each gas passage.

The embodiment of the present invention will be described with reference to FIGS. 14 to 18.

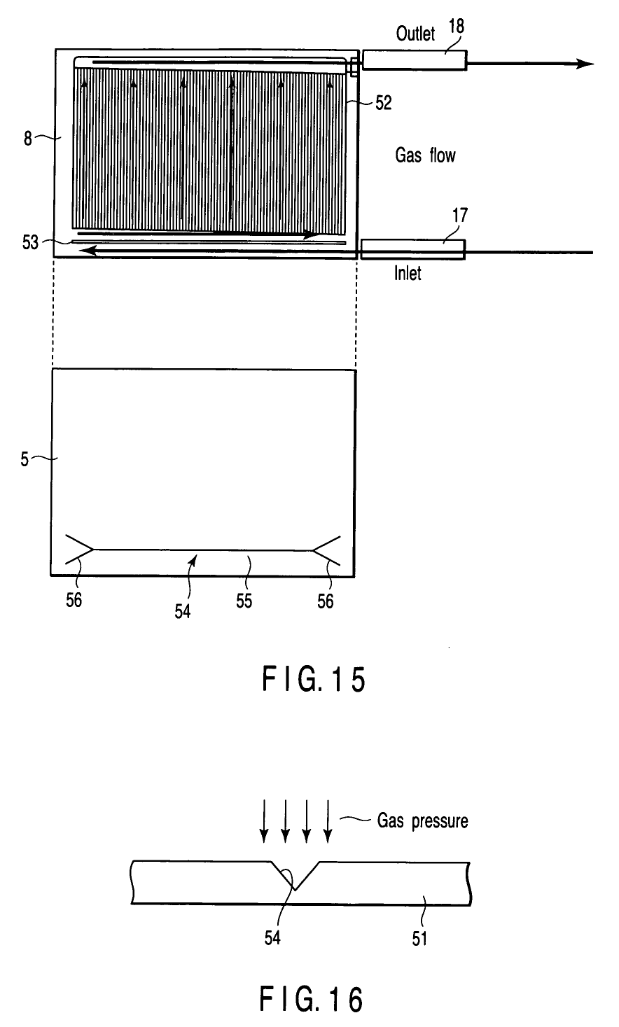

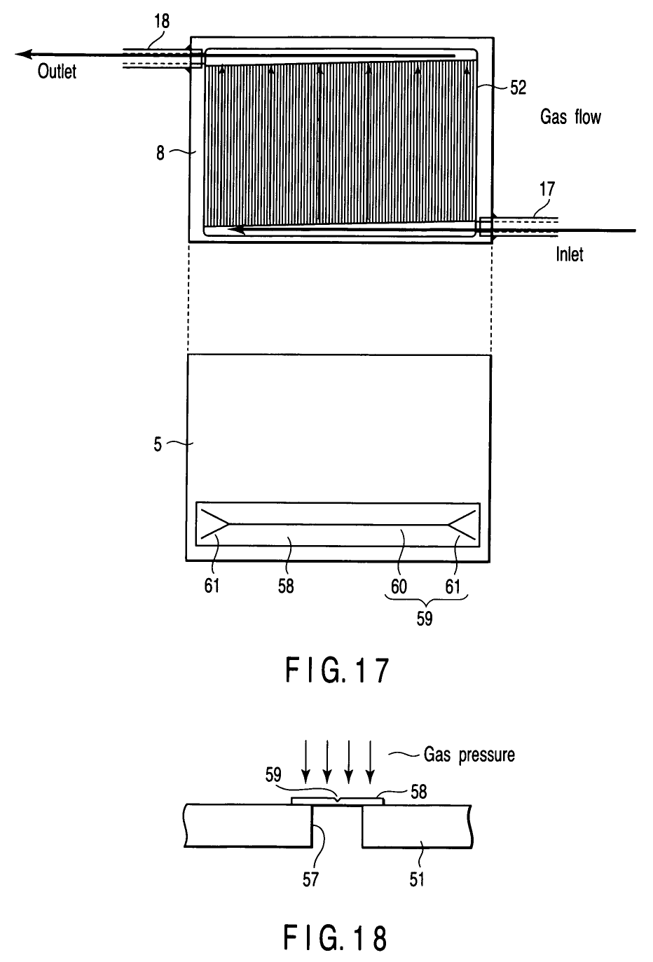

FIG. 14 is a perspective view schematically showing the reformer and combustor for use in the fuel reforming apparatus according to the fifth embodiment of the invention. FIG. 15 is a plan view showing an example of the positional relation between the gas flow passage of the combustor and the pressure releasing unit of the reformer in the fuel reforming apparatus shown in FIG. 14. FIG. 16 is a sectional view showing the configuration of the pressure releasing unit of FIG. 15. FIG. 17 is a plan view showing another example of the positional relation between the gas flow passage of the combustor and the pressure releasing unit of the reformer in the fuel reforming apparatus of FIG. 14. FIG. 18 is a sectional view showing the configuration of the pressure releasing unit of FIG. 17.

The fuel reforming apparatus shown in FIG. 14 has the same configuration as that shown in FIG. 1 except that no catalyst unit 9 is provided and the configurations of the reformer 5 and the combustor 8 are different. The reformer 5 is arranged adjacent to the combustor 8. A partition wall 51 located on the border between the reformer 5 and the combustor 8 is shared by the reformer 5 and the combustor 8.

As shown in FIG. 15, the fuel cell exhaust gas take-in pipe 17 is connected to an inlet of the combustor 8. An outlet of the combustor 8 is formed on the same face as the inlet, and the discharge pipe 18 for discharging a combustion gas outside is connected to the outlet of the combustor 8. A plurality of gas passages 52 having a groove shape are provided in the combustor 8, each gas passage including combustion catalyst on its wall face. The gas passages 52 are provided substantially at right angle to the flow of a gas introduced from the inlet of the combustor 8. A partition wall 53 for forming the gas introduction passage is arranged such that it opposes the inlet of the gas passages 52 with a desired gap. Passages on both sides of the partition wall 53 function as gas introduction passages. That is, the gas introduced from the inlet of the combustor 8 passes a passage between the inner wall face of the housing and the partition wall 53, and then flows along the face opposite to the partition wall 53 and is introduced to the inlet of each gas passage 52. The gas discharged from the outlet of the gas passage 52 flows along the inner wall face of the housing, and is discharged from the outlet into the discharge pipe 18. As the combustion catalyst, the same one as described in the first embodiment may be used.

The reformer 5 includes a plurality of groove-shaped gas passages (not shown) in which the reforming catalyst is formed on the wall face thereof. An evaporated fuel from the evaporator is supplied to the gas passage in the reformer 5 through the supply passage 13. The evaporated fuel is reformed in the gas passage, and the reformed gas containing hydrogen is supplied to the supply passage 14 from the outlet of the gas passage and sent to the CO shift device 6 from the supply passage 14. As the reforming catalyst, the same one as described in the first embodiment may be used.

The partition wall 51 located on the border between the reformer 5 and the combustor 8 is formed of metal such as aluminum or stainless steel. The partition wall 51 has a pressure releasing unit 54. The pressure releasing unit 54 is located opposing the partition wall 53 and introduction passages formed on both sides of the partition wall 53. For example, as shown in FIG. 16, it is permissible to use a thin portion as the pressure releasing unit 54 by providing the partition wall 51 with a V-shaped cutout groove by means of pressing or etching. The thin portion is comprised of a straight portion 55 formed substantially in parallel to the introduction passage and a V-shaped portion 56 which is formed at both ends of the straight portion 55 to oppose the inlet and outlet of the introduction passage.

Such a reforming apparatus can rupture the pressure releasing unit 54 composed of the thin portion and introduce the reformed gas filling the reformer 5 into the combustor 8 through the pressure releasing unit 54 when the gas passage is clogged by a catalyst dropped from the passage in the reformer 5 or a mixing foreign matter so that the internal pressure of the reformer 5 rises abnormally. Because the thin portion has the straight portion 55 formed substantially in parallel to the introduction passage and the V-shaped portion 56 which is formed on both ends of the straight portion 55 to oppose the inlet and outlet of the introduction passage, the gas can be quickly supplied to all the gas passages 52 in the combustor 8.

A reformed gas contains a flammable gas. Examples of the flammable gas include an unused fuel (for example, carbon hydride, alcohol), highly explosive hydrogen and carbon monoxide harmful to the human body. The reformed gas is introduced into the combustor 8, and the flammable gas is converted to a harmless substance by the action of the combustion catalyst formed on the wall face of the gas passage 52 in the combustor 8. As a consequence, the highly explosive hydrogen and carbon monoxide harmful to humans can be prevented from being discharged out.

The fuel reforming apparatus according to the fifth embodiment of the invention is not restricted to the configurations shown in FIGS. 14 to 16 but may be constructed as described below. This example will be shown in FIGS. 17 and 18.

As shown in FIG. 17, the fuel cell exhaust gas take-in pipe 17 is connected to the inlet of the combustor 8. The plural gas passages 52 are arranged substantially at right angle to the flow of a gas introduced from the inlet of the combustor 8. The outlet of the combustor 8 is formed in a side opposite to the inlet, and the discharge pipe 18 for discharging out a combustion gas is connected to the outlet of the combustor 8. The gas introduced from the inlet of the combustor 8 flows along the inner wall face of the housing and introduced into the inlet of each gas passage 52. That is, the passage between the inner wall face of the housing and the inlet of the gas passage 52 functions as the gas introduction passage. The gas discharged from the outlet of the gas flow passage 52 flows along the inner wall face of the housing and is discharged out into the discharge pipe 18 through the outlet.

As shown in FIGS. 17 and 18, the pressure releasing unit 54 includes a pressure releasing hole 57 as a pressure releasing passage, a valve plate 58, and cutout grooves 59 formed in the valve plate 58. The rectangular pressure releasing hole 57 is formed at a position of the partition wall 51 opposing the gas introduction passage. The rectangular valve plate 58 composed of aluminum or stainless is mounted to a face on the side of the reformer 8 in an airtight state by laser welding so as to close the pressure releasing hole 57. The valve plate 58 has a V-shaped cutout groove 59 formed by pressing or etching. The cutout groove 59 is comprised of a straight portion 60 formed substantially in parallel to the gas introduction passage and V-letter portions 61 which are formed on both ends of the straight portion 60 to oppose the inlet and outlet of the introduction passage.

According to this reforming apparatus, when the gas passage is clogged with a catalyst dropped from the inner wall face of the passage in the reformer 5 or a mixing foreign matter so that the internal pressure of the reformer 5 rises abnormally, the cutout groove 59 is ruptured to introduce a reformed gas filling the reformer 5 into the combustor 8 through the ruptured cut-in groove 59 and pressure releasing hole 57. Because the cutout groove 59 has the straight portion 60 formed substantially parallel to the gas introduction passage and the V-letter portions 61 which are formed on both ends of the straight portion 60 to oppose the inlet and outlet of the introduction passage, the gas can be supplied to all the gas passage 52 in the combustor 8.

A reformed gas contains a flammable gas. Examples of the flammable gas include an unused fuel (for example, carbon hydride, alcohol), highly explosive hydrogen and carbon monoxide harmful to the human body. The reformed gas is introduced into the combustor 8, and the flammable gas is detoxified by the action of the combustion catalyst formed on the wall faces of the gas passage 52 in the combustor 8. As a consequence, the highly explosive hydrogen and carbon monoxide harmful to humans can be prevented from being discharged out.

The fuel reforming apparatus of the fifth embodiment may include the catalyst unit 9 described in the first embodiment or the oxygen supply member described in the second embodiment. Further, the fuel reforming apparatus of the fifth embodiment may be incorporated in the fuel cell system described in the third and fourth embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel reforming apparatus comprising:
a heat insulating container having an opening;
a reformer which is provided in the heat insulating container and reforms a fuel to obtain a reforming gas containing H₂ and CO;
a CO treatment unit reducing CO in the reforming gas;
a reformer heating unit comprising a first catalyst for a combustion reaction of hydrogen, configured to heat the reformer using the combustion reaction;
a heat insulating member which covers the opening of the heat insulating container; and
a catalyst unit provided in the heat insulating container and including a second catalyst for an combustion reaction of a flammable gas.

2. The fuel reforming apparatus according to claim 1, wherein the opening is perpendicular to a longitudinal direction of the insulating container, and
the catalyst unit is provided on an inner wall along the longitudinal direction of the insulating container.

3. The fuel reforming apparatus according to claim 1, further comprising an air pump which supplies oxygen to the reformer heating unit and the catalyst unit.

4. The fuel reforming apparatus according to claim 1, further comprising:
a detection unit detecting the flammable gas using a rise in temperature of the catalyst unit.

5. The fuel reforming apparatus according to claim 4, further comprising a fuel supply unit supplying the fuel to the reformer, and
wherein the detection unit is configured to stop the fuel supply unit when a rise amount of the temperature of the catalyst unit reaches 20° C. or more.

6. A fuel cell system comprises:
a heat insulating container having an opening;
a reformer which is provided in the heat insulating container and reforms a fuel to obtain a reforming gas containing H₂ and CO;
a CO treatment unit reducing CO in the reforming gas;
a fuel cell which is supplied with the reforming gas from the CO treatment unit;
a reformer heating unit comprising a first catalyst for a combustion reaction of hydrogen, configured to heat the reformer using the combustion reaction;
a heat insulating member which covers the opening of the heat insulating container; and
a catalyst unit provided in the heat insulating container and including a second catalyst for an combustion reaction of a flammable gas.

7. The fuel cell system according to claim 6, wherein the opening is perpendicular to a longitudinal direction of the insulating container, and
the catalyst unit is provided on an inner wall along the longitudinal direction of the insulating container.

8. The fuel cell system according to claim 6, further comprising an air pump which supplies oxygen to the reformer heating unit and the catalyst unit.

9. The fuel cell system according to claim 6, further comprising:
a detection unit detecting the flammable gas using a rise in temperature of the catalyst unit.

10. The fuel cell system according to claim 9, further comprising a fuel supply unit supplying the fuel to the reformer, and
wherein the detection unit is configured to stop the fuel supply unit when a rise amount of the temperature of the catalyst unit reaches 20° C. or more.

11. The fuel cell system according to claim 6, further comprising:
a housing in which the fuel cell are contained; and
a catalyst unit provided in the housing and including a second catalyst for an combustion reaction of a flammable gas.

12. A fuel cell system comprising:
a reformer which reforms a fuel to obtain a gas;
a fuel cell comprising at least one cell which occurs a power generation reaction by using the gas;
a first heater which includes a catalyst for a combustion reaction of an unused gas discharged from the fuel cell and heats the reformer using the combustion reaction;
a second heater which heats the reformer;
a temperature controller which executes feedback control on an output power of the second heater based on a temperature of the reformer; and
a heater power control unit controlling a power to be supplied to the second heater according to the following formula (1):
Wₒᵤₜ=W_{cntl}−ΔH_{cmb}×(F_{dsn}−NI/nF) (1)
where Wₒᵤₜ is the power (W) to be supplied to the second heater; W_{cntl} is the output power (W) of the second heater obtained from the feedback control of the temperature controller; ΔH_{cmb} is a combustion heat (J/mol) of the gas; F_{dsn} is a gas supply amount (mol/s) to said at least one cell; N is a quantity of cells which constitute said at least one cell; I is a current (A) per cell; n is a quantity of electrons involved in the power generation reaction; and F is a Faraday constant.

13. The fuel cell system according to claim 12, wherein the gas is hydrogen.

14. A fuel cell system comprising:
a reformer which reforms a fuel to obtain a gas;
a fuel cell comprising at least one cell which occurs a power generation reaction by using the gas;
a first heater which includes a catalyst for a combustion reaction of an unused gas discharged from the fuel cell and heats the reformer using the combustion reaction;
a second heater which heats the reformer;
a temperature controller which controls the temperature of the reformer; and
a heater power control unit controlling a power to be supplied to the second heater so as to satisfy the following formula (2):
Wₒᵤₜ=Q1+Q2−ΔH_{cmb}×(F_{dsn}−NI/nF) (2)
where Wₒᵤₜ is the power (W) to be supplied to the second heater; Q1 is a heat quantity (W) necessary for reforming in the reformer; Q2 is a heat loss quantity (W) at the reformer; ΔH_{cmb} is a combustion heat (J/mol) of the gas; F_{dsn} is a gas supply amount (mol/s) to said at least one cell; N is a quantity of cells which constitute said at least one cell; I is a current (A) per cell; n is a quantity of electrons involved in the power generation reaction; and F is a Faraday constant.

15. The fuel cell system according to claim 14, wherein the gas is hydrogen.

16. The fuel cell system according to claim 14, wherein the heater power control unit controls the power to be supplied to the second heater so as to satisfy the following formula (2), when the temperature of the reformer is 360° C. or lower.

17. A fuel reforming apparatus comprising:
a reformer which reforms a fuel to obtain a reforming gas containing hydrogen;
a combustor which includes a catalyst for combustion reaction of a flammable gas, and heats the reformer using the combustion reaction; and
a pressure releasing unit ruptured when an internal pressure of the reformer rises, thereby acting as a gas passage from the reformer to the combustor.

18. The fuel reforming apparatus according to claim 17, wherein the pressure releasing unit comprises a pressure releasing passage communicating with the reformer and the combustor, and a metal valve plate having a thin portion, the metal valve plate closing the pressure releasing passage.

19. A fuel cell system comprises:
a reformer which reforms a fuel to obtain a reforming gas containing hydrogen;
a fuel cell which generates a power by using hydrogen;
a combustor which includes a catalyst for combustion reaction of a flammable gas, and heats the reformer using the combustion reaction; and
a pressure releasing unit ruptured when an internal pressure of the reformer rises, thereby acting as a gas passage from the reformer to the combustor.

20. The fuel cell system according to claim 19, wherein the pressure releasing unit comprises a pressure releasing passage communicating with the reformer and the combustor, and a metal valve plate having a thin portion, the metal valve plate closing the pressure releasing passage.
